(19) United States
(12) Patent Application Publication
(10) Pub. No.: US 2004/0215784 A1
(43) Pub. Date: Oct. 28, 2004

(54) Distributed management of collaboration sessions including local and remote servers

(76) Inventors: Yan Qi, Fremont, CA (US); Tsung-Yen Chen, Fremont, CA (US)

Correspondence Address: VICTOR H. OKUMOTO, P.O. BOX 6120, FREMONT, CA, 94538, US

(21) Appl. No.: 10/424,392

(22) Filed: Apr. 28, 2003

(51) Int. Cl. G06F 15/16

(52) U.S. Cl. 709/227; 709/205; 709/206

(57) ABSTRACT

A method, apparatus and system are described for distributed management of a collaboration session including local and remote servers. A collaboration session request including a list of invitees is received from a user associated with a local-server. If the received list includes users associated with remote servers that are recognized as being capable of distributed management by the local server, then information is sent to those remote servers for distributed management of the collaboration session. Communication between users associated with the local server and each of the remote servers is done through a single persistent connection shared by all session participating users associated with that remote server.

### FIELD OF THE INVENTION

The present invention generally relates to the computer management of collaboration sessions and in particular, to a method, apparatus and system for distributed management of collaboration sessions including local and remote servers.

### BACKGROUND OF THE INVENTION

In a collaboration system such as that depicted in FIG. 1, a local server computer 101 hosts a collaboration session between users of local client computers such as 102˜106 and users of other client computers such as 121˜123. Although communications between the local server computer 101 and local client computers 102˜106 are efficiently handled through a local network communication means 110 such as a corporate controlled local area network, communications with the other client computers 121˜123 are not so efficiently handled since they employ individual socket connections such as 141˜143 that are established through a communication medium 130 such as the Internet.

The local server computer 101 generally has many important tasks to perform in addition to managing the collaboration session. Therefore, it is useful to reduce the CPU time that it expends in managing the collaboration session so as to make more of its CPU time available to perform such other important tasks. Establishing and maintaining multiple socket connections such as 141—143 are particularly CPU time consuming activities, as well as supervising the entry, participation and exit of all users on the local and other client computers participating in the collaboration session.

### OBJECTS AND SUMMARY OF THE INVENTION

Accordingly, one object of the present invention is to provide a method, apparatus and/or system for minimizing the CPU time expended by a local server computer in managing a collaboration session including local and other client computers.

Another and more particular object is to provide a method, apparatus and/or system for distributed management of collaboration sessions including local and remote servers.

These and additional objects are accomplished by the various aspects of the present invention, wherein briefly stated, one aspect of the invention is a method for distributed management of a collaboration session including local and remote servers, comprising: receiving a request to schedule a collaboration session, the request initiated by a user associated with a local server and including a list of invitees; sorting the list of the invitees so as to generate a remote server list including individual of the invitees associated with a remote server; and sending information of the collaboration session including the remote server list to the remote server for distributed management of the collaboration session between the local and remote servers.

Another aspect is a method for distributed management of a collaboration session including local and remote servers, comprising: receiving information of a collaboration session from a local server, the information including a remote server list identifying invitees to the collaboration session who are associated with a remote server; and inviting individual of the invitees on the remote server list to participate in the collaboration session.

Another aspect is a method for distributed management of a collaboration session including local and remote servers, comprising: receiving a request to schedule a collaboration session, the request initiated by a first user associated with a local server and including a list of invitees; sorting the list of the invitees so as to generate one or more remote server lists, each of the one or more remote server lists including individual of the invitees associated with a corresponding one of one or more remote servers; and sending information of the collaboration session to individual of the one or more remote servers for distributed management of the collaboration session between the local and the one or more remote servers, wherein the information includes a corresponding one of the one or more remote server lists.

Still another aspect is an apparatus for distributed management of a collaboration session including local and remote servers. The apparatus comprises a local server, wherein the local server is configured to receive a request including a list of invitees to schedule a collaboration session; sort the list of the invitees so as to generate a remote server list including individual of the invitees associated with a remote server; and send information of the collaboration session including the remote server list to the remote server that is configured to invite the individual of the invitees included in the remote server list to participate in the collaboration session after receiving the information of the collaboration session.

Another aspect is an apparatus for distributed management of a collaboration session including local and remote servers. The apparatus in this case comprises a remote server configured to: receive information of a collaboration session from a local server, wherein the information includes a remote server list identifying invitees to the collaboration session who are associated with the remote server; and invite individual of the invitees on the remote server list to participate in the collaboration session.

Yet another aspect is a method for distributed management of a collaboration session including local and remote servers, comprising: receiving a request to schedule a collaboration session including information of invitees to the collaboration session; sorting the invitees into a local server list, one or more remote server lists, and a direct list according to whether individual of the invitees is associated with a local server receiving the request or associated with one or more remote servers identified in a remote server list; and sending the one or more remote server lists to corresponding of the one or more remote servers for distributed management of the collaboration session between the local and the one or more remote servers.

Still another aspect is a system for distributed management of a collaboration session. The system comprises a local server, and one or more remote servers recognized by the local server. The local server in this case is configured to sort a list of invitees received with a request to schedule a collaboration session into a local server list and one or more remote server lists; manage entry, participation, and exit in the collaboration session of individual of the invitees on the local server list; and send the one or more remote server lists to corresponding ones of the remote servers individually configured to manage entry, participation through a persistent connection established with the local server, and exit from the collaboration session of individual of the invitees on a corresponding one of the one or more remote server lists.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates a diagram of a prior art collaboration system.

FIG. 2 illustrates a diagram of a collaboration system utilizing aspects of the present invention.

FIG. 3 illustrates a diagram of a simplified collaboration system including software modules utilizing aspects of the present invention.

FIGS. 4˜10 illustrate flow diagrams of various aspects of a method for distributed management of a collaboration session including local and remote servers, utilizing aspects of the present invention.

### DETAILED DESCRIPTION OF THE PREFERRED EMBODIMENT

As used herein, the term “local server” means a server associated with a user initiating a request to schedule a collaboration session; the term “remote server” means other servers that are recognized by the local server as being capable of distributed management of the collaboration session; the term “network” means a server and client computers currently being used by users associated with the server; the term “local network” means a network including a local server; the term “remote network” means a network including a remote server; the term “local client” means a client included in a local network; the term “remote client” means a client included in a remote network; and the term “direct client” means a client that is not included in a local or remote network.

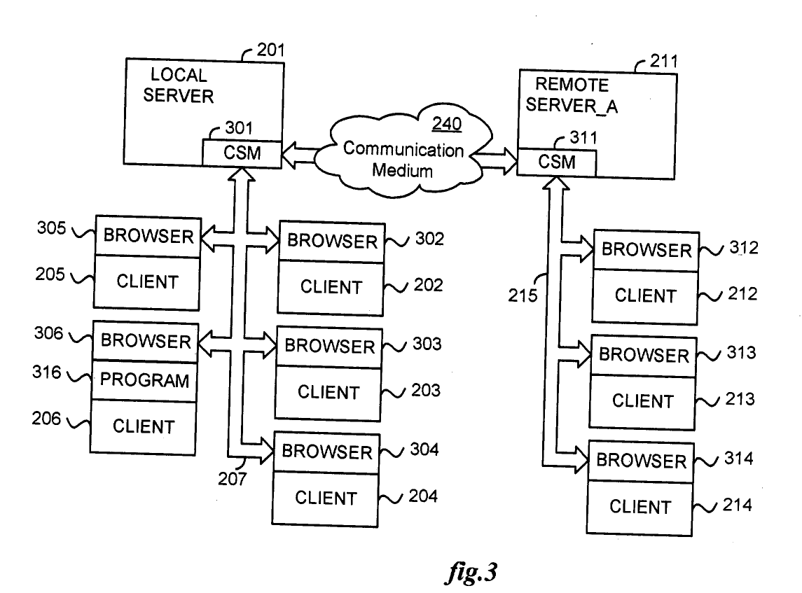

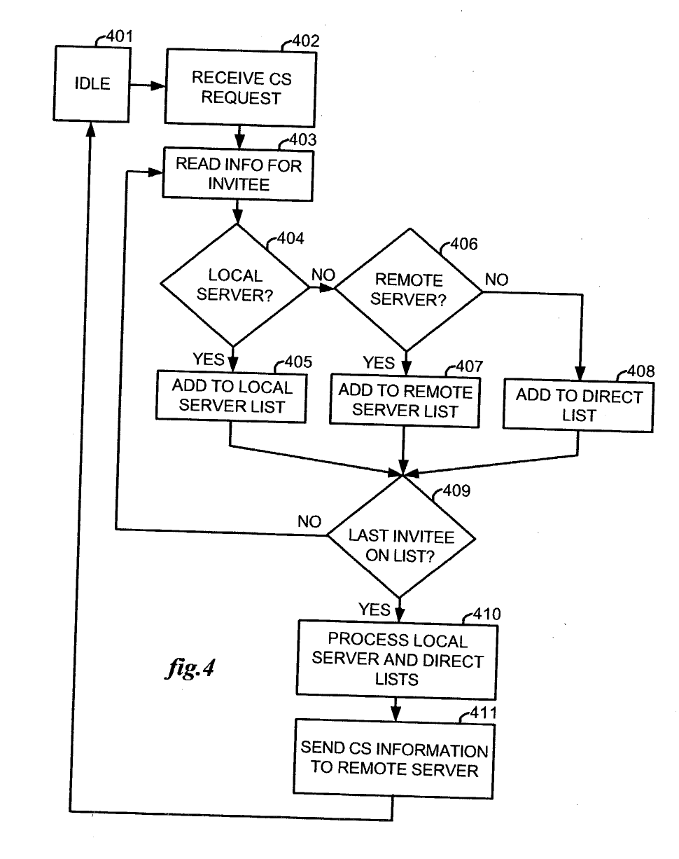

Referring now to FIG. 2, a collaboration system includes, as an example, a local network 200, two remote networks 210 and 220, and a direct client computer 231 that are capable of communicating with each other through a communication medium 240 such as the Internet. The local network 200 includes a local server computer 201 communicating with local client computers 202˜206 through a local network communication means 207 such as a first company's corporate controlled Intranet implemented, for example, within their Local Area Network (“LAN”), Wide Area Network (“WAN”) or Virtual Private Network (“VPN”). Similarly, remote network 210 includes a remote server computer 211 communicating with remote client computers 212˜214 through a remote network communication means 215 such as a second company's corporate controlled Intranet implemented, for example, within their LAN, WAN or VPN. Likewise, remote network 220 includes a remote server computer (not shown) communicating with remote client computers (not shown) through a remote network communication means (not shown) such as a third company's corporate controlled Intranet implemented, for example, within their LAN, WAN or VPN.

When a user initiates a request to schedule a collaboration session, a list of invitees to the collaboration session is provided by the user along with the request. The requesting user and each invitee on the list are preferably associated with their respective servers. For example, in the present case, the requesting user is associated with the server 201, and is operating one of the client computers 202˜206. The individual invitees, on the other hand, may be associated with the server 201 or any other server.

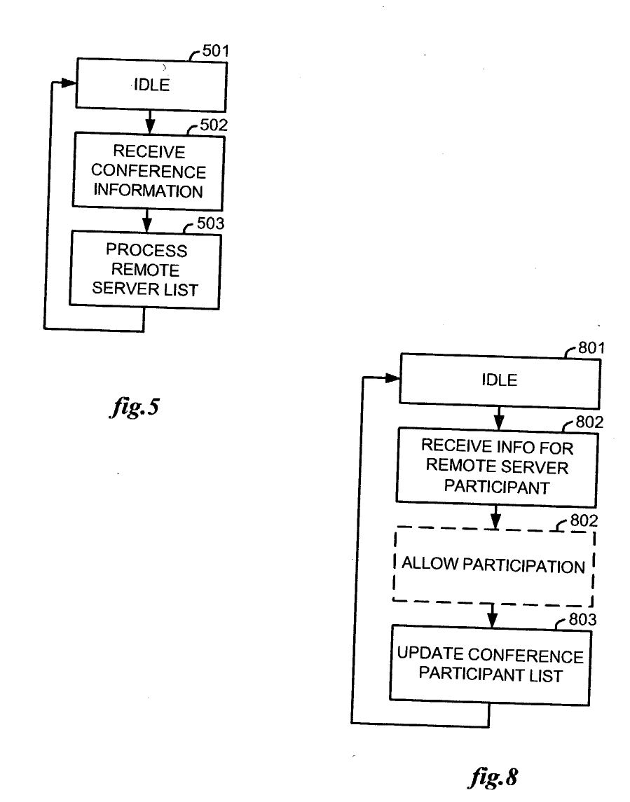

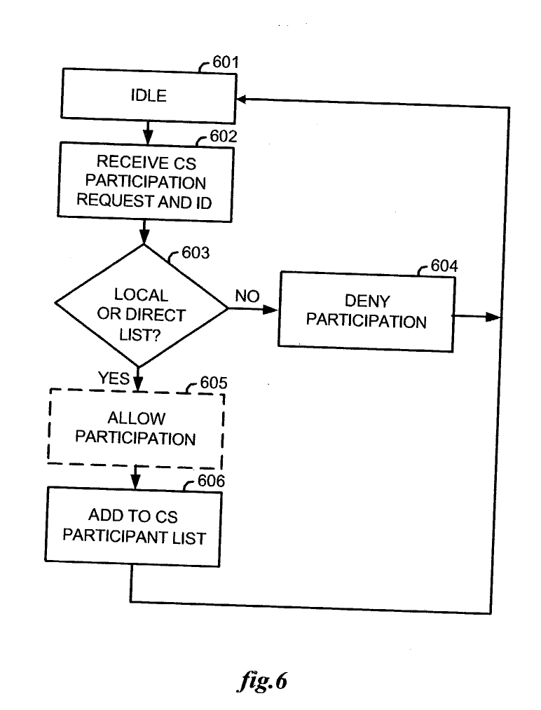

FIG. 3 illustrates a block diagram of a portion of the collaboration system depicted in FIG. 2, including certain software modules used for distributed management of a collaboration session between the server computers 201 and 211. In particular, general management as well as distributed management of the collaboration session is provided in this case by identical copies 301 and 311 of a collaboration session manager software module (“CSM”) respectively residing on the server computers 201 and 211.

General management features of the collaboration session manager software module are described, for example, in commonly owned U.S. patent application Ser. No. 09/563,658 entitled “Method and Apparatus for Conducting an Interactive Design Conference over the Internet,” filed May 2, 2000, which is incorporated herein by this reference; commonly owned U.S. patent application Ser. No. 10,318,393 entitled “Method and Apparatus for Conducting a Collaboration Session in which Screen Displays are Commonly Shared with Participants,” filed Dec. 11, 2002, which is also incorporated herein by this reference; and commonly owned U.S. patent application Ser. No. 10,388,265 entitled “Apparatus and Method for Granting/Denying User Requests for Features of an Application Program,” filed Mar. 13, 2003, which is also incorporated herein by this reference.

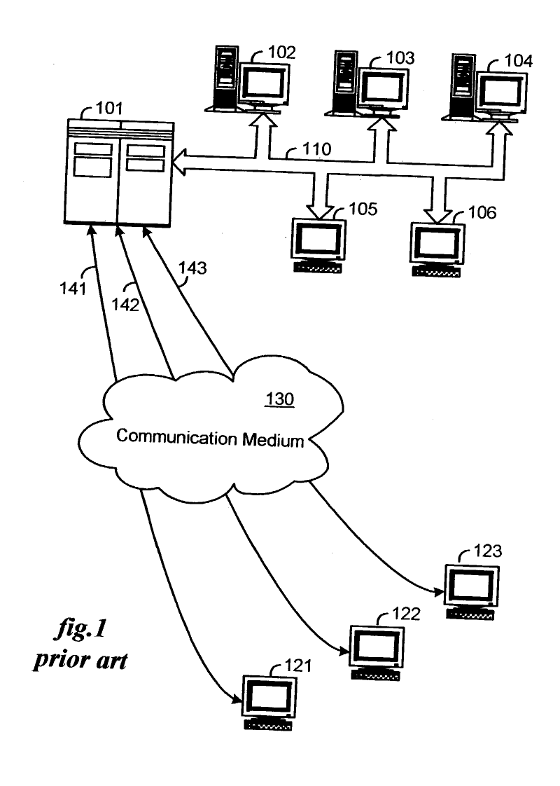

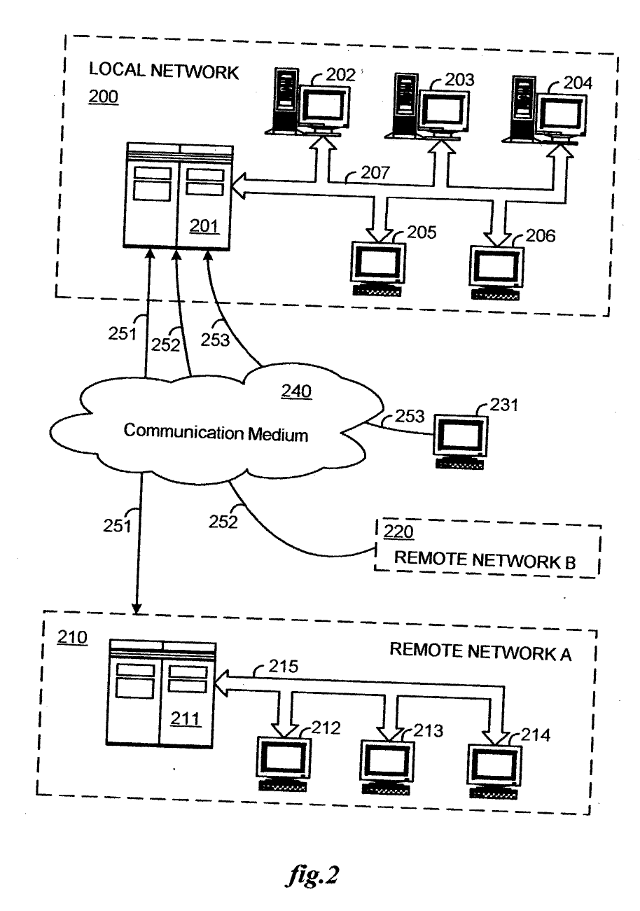

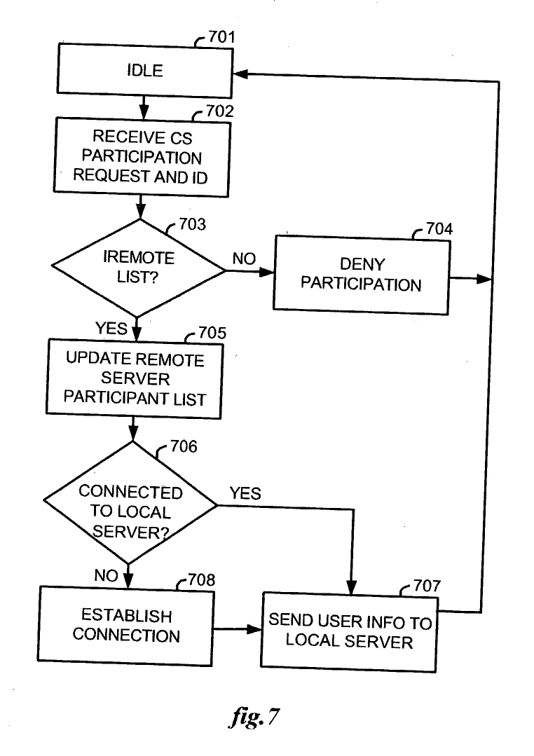

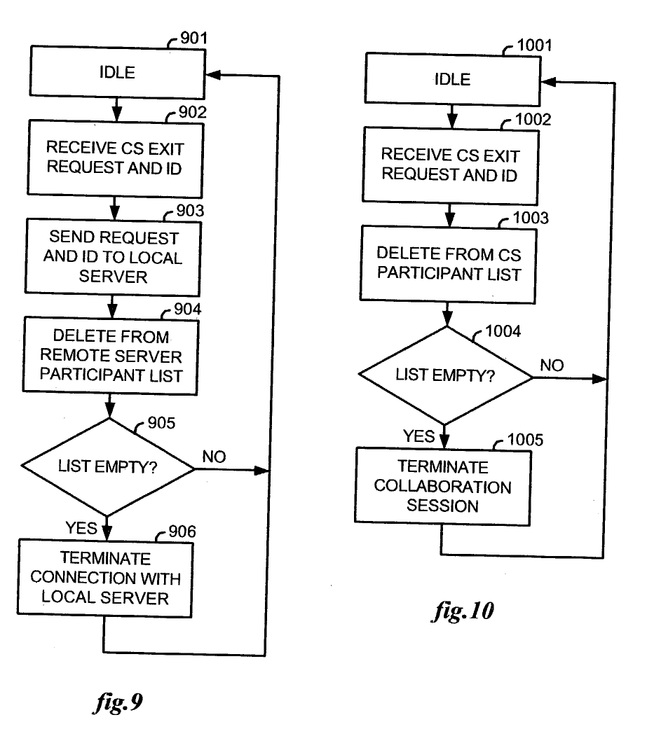

Distributed management features and operation are described herein in reference to FIGS. 4˜10. In the present example, the user of client computer 206 has initiated a request to schedule a collaboration session and transmitted that request through the network communication means 207 to the CSM 301 residing on the server computer 201. Consequently, the server computer 201 is designated the local server, and the CSM copy 301 operates in the local server or host mode. A list of invitees to the collaboration session is provided along with the request. In the present example, a user of client computer 212 is listed as an invitee. Information for each invitee on the list preferably includes a unique identification of the invitee such as an email address, and an IP address for a server associated with the user, which in this case is the server computer 211. The copy of the CSM 301 residing on the local server 201 checks a list of servers known by it to have a copy of the CSM installed, and if the invitee's associated server is on that so-called remote server list, then the server is determined to be capable of distributed management of a collaboration session. Consequently in this example, the server computer 211 is designated a remote server, and the CSM copy 311 residing on it operates in the remote server mode. The client computer being used by an invitee who is associated with a server that is not the local server and is not on the remote server list is treated as a direct client computer and consequently, the client computer being used by that user or invitee is handled by the CSM 301 in the same manner as the prior art client computers 121˜123 described in reference to FIG. 1.

In the following description of various aspects of a method for distributed management of a collaboration session including local and remote servers, the remote server computer 211 and in particular, the copy of the CSM 311 residing on the remote server computer 211 is repeatedly mentioned as an example in describing those aspects. It is to be appreciated, however, that where reference to the remote server 211 and its copy of the CSM 311 is made, such methods are fully applicable to all remote server computers associated with remote users participating in the collaboration session.

FIG. 4 illustrates a flow diagram of one aspect of a method for distributed management of a collaboration session that is performed by the copy of the CSM 301 in local server mode. In 401, the method starts in a so-called idle mode. In 402, it receives the collaboration session request initiated by the user of client computer 206, along with a list of invitees to the collaboration session. Other information provided with the request is a subject or title for the collaboration session and a scheduled start time. In 403, information of the server IP address associated with an invitee is read. In 404, a determination is made whether the invitee is associated with the local server by comparing the server IP address associated with the invitee to that of the local server. If the determination results in a match, then in 405, the identification of the invitee is added to a local server list. On the other hand, if the determination does not result in a match, then in 406, a determination is made whether the server IP address matches one of the servers on a remote server list. As previously explained, all servers on this list are known by the local server 201 to have a copy of the CSM residing on it. If the determination results in a match, then in 407, the identification of the invitee is added to a remote server list corresponding to the matched server. On the other hand, if the determination in 406 does not result in a match, then in 408, the identification of the invitee is added to a direct list.

In 409, a determination is made whether the current invitee being processed is the last invitee on the list of invitees. If it is the last invitee, then the method proceeds to 410 and 411. On the other hand, if it is not the last invitee, then the method jumps back to 403 to process the next invitee on the list through 403˜409. After all invitees on the list have been sorted into one of the local server list, a remote server list, or the direct list, then in 410, the local server and direct lists are processed by inviting the invitees listed therein to the collaboration session. Included in the invitation is the subject of the collaboration session, its start time, a URL of a web page hosted by the local server 201 that the invitee is to go to when requesting participation in the collaboration session, and optionally, a collaboration session identification number or code. The invitation can be sent by email to an email address of the invitee, or by instant messenger to a client computer being operated at the time by the invitee using a conventional or proprietary instant messenger service. Although 411 is shown as following 410, it is to be appreciated that it may also be performed before or concurrently with 410, with the resulting method still being within the scope of the present invention. In 411, information of the collaboration session is sent to the copy of the CSM residing on each remote server computer corresponding to a non-empty remote server list. The information sent in this case preferably includes for each such remote server computer, at least the subject of the collaboration session, its start time, and the remote server list including invitees associated with that remote server computer. Optionally, it may also include other items such as a collaboration session identification number or code. After 410 and 411 are completed, then the method goes into idle mode as indicated by jumping back to 401.

FIG. 5 illustrates a flow diagram of another aspect of a method for distributed management of a collaboration session that is performed by the copy of the CSM 311 in remote server mode. In 501, the method starts in a so-called idle mode. In 502, information of the collaboration session which was previously sent as described in reference to 411 in FIG. 4 by the copy of the CSM 301 residing on the local server computer 201 is received. In 503, the remote server list corresponding to the remote server computer 211 and included in the received information is processed by inviting the invitees listed therein to the collaboration session. Included in the invitation is the subject of the collaboration session, its start time, a URL of a web page hosted by the remote server 211 that the invitee is to go to when requesting participation in the collaboration session, and optionally, a collaboration session identification number or code. The invitation can be sent by email to an email address of the invitee, or by instant messenger to the client computer being operated at the time by the invitee using a conventional or proprietary instant messenger service. After all invitees on the remote network list have been invited, then the method goes into idle mode as indicated by jumping back to 501.

FIG. 6 illustrates a flow diagram of another aspect of a method for distributed management of a collaboration session that is performed by the copy of the CSM 301 in local server mode to manage local and direct user admission to the collaboration session. In 601, the method starts in a so-called idle mode. In 602, a request to participate in the collaboration session is received from a user operating a local or direct client computer, along with an identification for the requesting user. The request is preferably generated by the user accessing a web page hosted by the local server 201, providing a unique user identification, and selecting one of the scheduled collaboration sessions indicated thereon that is identified by a collaboration session subject and start time. In 603, a determination is made whether the requesting user is authorized to participate in the collaboration session by matching the user's identification against those included in the local network and direct lists. Alternatively, this step may be performed as part of 602 when the user provides his or her identification. In that case, the scheduled collaboration sessions listed on the web page would only include those sessions to which the user has been included as an invitee. In 604, if no match is found, the user is denied participation in the collaboration session. On the other hand, if a match is found, then in 605, the user is allowed to participate in the collaboration session and in 606, the user's identification is added to a conference participant list. Note that 605 is in a dotted box in this case, because it does not necessary imply any additional action taken by the CSM 301, but is included herein for descriptive purposes. Following both 604 and 606, the method goes back into idle mode as indicated by jumping back to 601.

FIG. 7 illustrates a flow diagram of another aspect of a method for distributed management of a collaboration session that is performed by the copy of the CSM 311 in remote server mode to manage remote user admission to the collaboration session. In 701, the method starts in a so-called idle mode. In 702, a request to participate in the collaboration session is received from a user operating a remote client computer, along with an identification for the requesting user. The request is preferably generated in this case in a similar manner as described in reference to 602 of FIG. 6, with the exception that the web page described therein is hosted instead by the remote server computer 211. In 703, a determination is made whether the requesting user is authorized to participate in the collaboration session by matching the user's identification against those included in the remote network list previously provided to the remote server 211 as described in reference to 411 of FIG. 4. Alternatively, this step may be performed as part of 702 when the user provides his or her identification. In that case, the scheduled collaboration sessions listed on the web page would only include those sessions to which the user has been included as an invitee. In 704, if no match is found, the user is denied participation in the collaboration session. On the other hand, if a match is found, then in 705, the user's identification is added to a remote network participant list for the remote server computer 211. In 706, a determination is then made whether a persistent connection between the remote server computer 211 and the local server computer 201 has been established. If the determination in 706 is YES, then in 707, information of the user is transmitted to the local server 201 to allow the user to participate in the collaboration session. On the other hand, if the determination in 706 is NO, then in 708, a persistent connection is established and maintained between the remote server computer 211 and the local server computer 201 by a thread of the CSM 311. The persistent connection in this case is preferably established over the Internet through HTTP or a TCP/IP socket. For security purposes, SSL is also preferably employed. Following both 704 and 707, the method goes back into idle mode as indicated by jumping back to 701.

If a collaboration session identification number or code is provided to invitees, the methods described in reference to FIGS. 6 and 7 may be modified by confirming whether a collaboration session identification number or code provided by a user with a collaboration session participation request is the correct identification number or code for that collaboration session, instead of checking user identifications against the local server, remote server and direct lists. This allows a “backdoor” entry into the collaboration session by users inadvertently omitted from the original invitee list. Although such a method may be simpler to implement and is fully contemplated to be within the scope of the present invention, it is not the preferred method for security reasons, because it does not prevent improper “eavesdropping” or “spying” on the collaboration session by users stealing or otherwise obtaining improper access to the collaboration session identification number or code.

FIG. 8 illustrates a flow diagram of another aspect of a method for distributed management of a collaboration session that is performed by the copy of the CSM 301 in local server mode to keep track of participants in the collaboration session. In 801, the method starts in a so-called idle mode. In 802, information of a newly added remote participant is received from one of the remote server computers such as described, for example, in 707 of FIG. 7. In 803, the newly admitted remote participant is allowed to participate in the collaboration session in much the same manner as for local and direct users described in reference to 605 of FIG. 6, and in 804, the identification of the newly admitted remote participant, as included in the received information, is added to the conference participant list in much the same manner as for local and direct users described in reference to 606 of FIG. 6. Following 804 and 806, the method goes back into idle mode as indicated by jumping back to 801.

FIG. 9 illustrates a flow diagram of another aspect of a method for distributed management of a collaboration session that is performed by the copy of the CSM 311 in remote server mode to manage remote user exit from the collaboration session. In 901, the method starts in a so-called idle mode. In 902, a request to exit from the collaboration session is received from a remote client computer associated with a user initiating the request, along with an identification for the requesting user. In 903, the request and user identification are relayed to the CSM 301 residing on the local server 201. In 904, the user identification is deleted from the remote network participant list. In 905, a determination is made whether the remote network participant list is now empty. If the determination in 905 is YES, then in 906 the thread of the CSM 311 maintaining the persistent connection now terminates the connection. On the other hand, if the determination in 905 is NO and also following 906, the method goes back into idle mode as indicated by jumping back to 901.

FIG. 10 illustrates a flow diagram of another aspect of a method for distributed management of a collaboration session that is performed by the copy of the CSM 301 in local server mode to manage user exit from and termination of the collaboration session. In 1001, the method starts in a so-called idle mode. In 1002, a request to exit from the collaboration session is received from a local or direct client computer associated with a user initiating the request, or a remote server computer relaying such a request from a remote client computer as described in reference to 903 of FIG. 9, along with an identification for the requesting user. In 1003, the user identification is deleted from the collaboration session participant list. In 1004, a determination is made whether the collaboration session participant list is now empty. If the determination in 1004 is YES, then in 1005 the collaboration session is terminated. On the other hand, if the determination in 1004 is NO and also following 1005, the method goes back into idle mode as indicated by jumping back to 1001.

Although the various aspects of the present invention have been described with respect to a preferred embodiment, it will be understood that the invention is entitled to full protection within the full scope of the appended claims.

We claim:

1. A method for distributed management of a collaboration session including local and remote servers, comprising:
receiving a request to schedule a collaboration session, said request initiated by a user associated with a local server and including a list of invitees;
sorting said list of said invitees so as to generate a remote server list including individual of said invitees associated with a remote server; and
sending information of said collaboration session including said remote server list to said remote server for distributed management of said collaboration session between said local and said remote servers.

2. The method according to claim 1, wherein said sorting includes sorting said list of said invitees so as to also generate a local server list including individual of said invitees associated with said local server.

3. The method according to claim 2, further comprising inviting said individual of said invitees on said local server list to participate in said collaboration session.

4. The method according to claim 3, wherein said inviting includes sending emails to said individual of said invitees on said local server list.

5. The method according to claim 3, wherein said inviting includes sending instant messages to said individual of said invitees on said local server list.

6. The method according to claim 2, wherein said sorting includes sorting said list of said invitees so as to also generate a direct list including individual of said invitees that are not associated with said local server or said remote server.

7. The method according to claim 6, further comprising inviting said individual of said invitees on said direct list to participate in said collaboration session.

8. The method according to claim 7, wherein said inviting includes sending emails to said individual of said invitees on said direct list.

9. The method according to claim 7, wherein said inviting includes sending instant messages to said individual of said invitees on said direct list.

10. A method for distributed management of a collaboration session including local and remote servers, comprising:
receiving information of a collaboration session from a local server, said information including a remote server list identifying invitees to said collaboration session who are associated with a remote server; and
inviting individual of said invitees on said remote server list to participate in said collaboration session.

11. The method according to claim 10, wherein said information of said collaboration session includes a subject and a start time for said collaboration session.

12. The method according to claim 11, wherein said inviting includes sending emails including said subject and said start time for said collaboration session to said individual of said invitees on said remote server list.

13. The method according to claim 11, wherein said inviting includes sending instant messages including said subject and said start time for said collaboration session to said individual of said invitees on said remote server list.

14. The method according to claim 10, further comprising:
receiving a request initiated by a user associated with said remote server to participate in said collaboration session;
determining whether an identification associated with said user is included in said remote server list; and
denying participation in said collaboration session to said user if said identification is not included in said remote server list.

15. The method according to claim 14, further comprising sending said identification associated with said user to said local server if said identification is included in said remote server list so that said user is allowed to participate in said collaboration session.

16. The method according to claim 15, wherein said sending said identification to said local server comprises sending said identification to said local server over a persistent connection established between said local server and said remote server.

17. The method according to claim 16, further comprising establishing said persistent connection over the Internet using HTTP.

18. The method according to claim 16, further comprising adding said identification associated with said user to a remote server participant list if said identification is included in said remote server list.

19. The method according to claim 18, further comprising:
receiving an indication that said user is no longer participating in said collaboration session;
deleting said identification associated with said user from said remote server participant list; and
terminating said persistent connection established between said local server and said remote server if said remote server participant list is empty following said deleting.

20. A method for distributed management of a collaboration session including local and remote servers, comprising:
receiving a request to schedule a collaboration session, said request initiated by a first user associated with a local server and including a list of invitees;
sorting said list of said invitees so as to generate one or more remote server lists, each of said one or more remote server lists including individual of said invitees associated with a corresponding one of one or more remote servers; and
sending information of said collaboration session to individual of said one or more remote servers for distributed management of said collaboration session between said local and said one or more remote servers, wherein said information includes a corresponding one of said one or more remote server lists.

21. The method according to claim 20, wherein said sorting includes sorting said list of invitees so as to also generate a local server list including individual of said invitees associated with said local server.

22. The method according to claim 21, further comprising inviting said individual of said invitees on said local server list to participate in said collaboration session.

23. The method according to claim 21, wherein said sorting includes sorting said list of invitees so as to also generate a direct list including individual of said invitees that are not associated with said local server or said one more remote servers.

24. The method according to 23, further comprising inviting said individual of said invitees on said direct list to participate in said collaboration session.

25. The method according to claim 1, wherein said information of said collaboration session includes a subject and a start time for said collaboration session.

26. The method according to claim 25, further comprising:
receiving at individual of said one or more remote servers, information of said collaboration session including a corresponding one of said one or more remote server lists identifying invitees to said collaboration session who are associated with said individual of said one or more remote servers; and
inviting individual of said invitees on said corresponding one of said one or more remote server lists to participate in said collaboration session.

27. The method according to claim 26, further comprising:
receiving a request initiated by a second user associated with one of said one or more remote servers to participate in said collaboration session;
determining whether an identification associated with said second user is included in one of said one or more remote server lists that corresponds to said one of said one or more remote servers; and
denying participation in said collaboration session to said second user if said identification is not included in said one of said one or more remote server lists that corresponds to said one of said one or more remote servers.

28. The method according to claim 27, further comprising sending said identification associated with said second user to said local server through a persistent connection established between said local server and said one of said one or more remote servers if said identification is included in said one of said one or more remote server lists so that said second user is allowed to participate in said collaboration session.

29. The method according to claim 28, further comprising adding said identification associated with said second user to a remote server participant list corresponding to said one of said one or more remote server lists if said identification is included in said one of said one or more remote server lists.

30. The method according to claim 29, further comprising:
receiving an indication that said second user is no longer participating in said collaboration session;
deleting said identification associated with said second user from said remote server participant list; and
terminating said persistent connection established between said local server and said one of said one or more remote servers if said remote server participant list is empty following said deleting.

31. An apparatus for distributed management of a collaboration session including local and remote servers, comprising a local server configured to:
receive a request including a list of invitees to schedule a collaboration session;
sort said list of said invitees so as to generate a remote server list including individual of said invitees associated with a remote server; and
send information of said collaboration session including said remote server list to a remote server that is configured to invite said individual of said invitees included in said remote server list to participate in said collaboration session after receiving said information of said collaboration session.

32. The apparatus according to claim 31, wherein said information of said collaboration session includes a subject and a start time for said collaboration session.

33. The apparatus according to claim 31, wherein said local server is further configured to sort said list of said invitees so as to also generate a local server list including individual of said invitees associated with said local server.

34. The apparatus according to claim 33, wherein said local server is further configured to invite said individual of said invitees on said local server list to participate in said collaboration session.

35. The apparatus according to claim 33, wherein said local server is further configured to sort said list of said invitees so as to also generate a direct list including individual of said invitees that are not associated with said local server or said remote server.

36. The apparatus according to claim 35, wherein said local server is further configured to invite said individual of said invitees on said direct list to participate in said collaboration session.

37. The apparatus according to claim 31, wherein said local server is further configured to establish a persistent connection with said remote server upon receiving a request to do so by said remote server so as to allow participation in said collaboration session by participating ones of said invitees associated with said remote server.

38. An apparatus for distributed management of a collaboration session including local and remote servers, comprising a remote server configured to:
receive information of a collaboration session from a local server, wherein said information includes a remote server list identifying invitees to said collaboration session who are associated with said remote server; and
invite individual of said invitees on said remote server list to participate in said collaboration session.

39. The apparatus according to claim 38, wherein said information of said collaboration session includes a subject and a start time for said collaboration session.

40. The apparatus according to claim 38, wherein said remote server is further configured to:
receive a request initiated by a user associated with said remote server to participate in said collaboration session;
determine whether an identification associated with said user is included in said remote server list; and
deny participation in said collaboration session to said user if said identification is not included in said remote server list.

41. The apparatus according to claim 40, wherein said remote server is further configured to send said identification associated with said user to said local server over a persistent connection established between said local server and said remote server if said identification is included in said remote server list so that said user is allowed to participate in said collaboration session.

42. The apparatus according to claim 41, wherein said persistent connection is established over the Internet using HTTP.

43. The apparatus according to claim 41, wherein said remote server is further configured to add said identification associated with said user to a remote server participant list if said identification is included in said remote server list.

44. The apparatus according to claim 43, wherein said remote server is further configured to:
receive an indication that said user is no longer participating in said collaboration session;
delete said identification associated with said user from said remote server participant list; and
terminate said persistent connection established between said local server and said remote server if said remote server participant list is empty following said deleting.

45. A method for distributed management of a collaboration session including local and remote servers, comprising:
receiving a request to schedule a collaboration session including information of invitees to said collaboration session;
sorting said invitees into a local server list, one or more remote server lists, and a direct list according to whether individual of said invitees is associated with a local server receiving said request or associated with one or more remote servers identified in a remote server list; and
sending said one or more direct server lists to corresponding of said one or more remote servers for distributed management of said collaboration session between said local and said one or more remote servers.

46. A system for distributed management of a collaboration session, comprising:
a local server; and
one or more remote servers recognized by said local server;
wherein said local server is configured to sort a list of invitees received with a request to schedule a collaboration session into a local server list and one or more remote server lists; manage entry, participation, and exit in said collaboration session of individual of said invitees on said local server list; and send said one or more remote server lists to corresponding ones of said remote servers individually configured to manage entry, participation through a persistent connection established with said local server, and exit from said collaboration session of individual of said invitees on a corresponding one of said one or more remote server lists.

47. The system according to claim 46, wherein said local server is further configured to sort said list of invitees into a direct list including individual of said invitees who are not associated with said local server or any of said one or more remote servers; and manage entry, participation, and exit in said collaboration session of, individual of said invitees on said direct list.

48. The system according to claim 46, wherein said persistent connection is established by said individual of said corresponding ones of said remote servers when a first one of said invitees that is associated with said individual of said corresponding ones of said remote servers enters said collaboration session.

49. The system according to claim 46, wherein information is relayed through said persistent connection between said local server and said individual of said corresponding ones of said remote servers for all of said invitees that are associated with said individual of said corresponding ones of said remote servers during said collaboration session.

50. The system according to claim 46, wherein said persistent connection is terminated by said individual of said corresponding ones of said remote servers when all of said invitees that are associated with said individual of said corresponding ones of said remote servers and participating in said collaboration session have terminated their participation.
